(19) United States
(12) Patent Application Publication
(10) Pub. No.: US 2013/0326281 A1
(43) Pub. Date: Dec. 5, 2013

(54) X-Tracer: A Reconfigurable X-Tolerance Trace Compressor for Silicon Debug

(71) Applicants: SynTest Technologies, Inc., Sunnyvale, CA (US); The Chinese University of Hong Kong, Hong Kong (CN)

(72) Inventors: Qiang Xu, Hong Kong (CN); Feng Yuan, Hong Kong (CN); Xiao Liu, Hong Kong (CN); Laung-Terng Wang, Sunnyvale, CA (US)

(21) Appl. No.: 13/908,602

(22) Filed: Jun. 3, 2013

Related U.S. Application Data
(60) Provisional application No. 61/654,200, filed on Jun. 1, 2012.

(51) Int. Cl. G06F 11/26

(52) U.S. Cl. CPC G06F 11/26
USPC 714/45

(57) ABSTRACT

An apparatus and method for compressing trace data containing unknown (X) bits in trace-based silicon debug, wherein redundant and/or reconfigurable MISRs and a non-X signature extraction algorithm are used to produce non-X signature that contains a maximized number of known (non-X) information bits.

This application claims the benefit of Provisional U.S. Patent Appl. Ser. No. 61/654,200, filed Jun. 1, 2012, and incorporated herein by reference.

### FIELD OF THE INVENTION

The present invention generally related to the field of silicon debug using design-for-debug (DFD) techniques. Specifically, the present invention relates to the field of trace-based silicon debug and trace data compression.

### BACKGROUND

The ever-increasing design complexity of integrated circuits (ICs) and the inherent inaccuracy of circuit models at high abstraction levels significantly challenge the effectiveness of pre-silicon verification techniques, and it is not uncommon that IC products need to go through multiple re-spins to be error-free (see Abramovici (2008)), despite the fact that more than half of the resources are devoted to verification tasks (see SIA (2003)). Consequently, to reduce expensive re-spins and time-to-market, silicon debug (also known as post-silicon validation) cannot be an afterthought and has become an essential step in today's IC design flow.

Since the core under debug (CUD) is a piece of silicon that has already been fabricated, the main challenge in silicon debug is the limited visibility of internal signals. To tackle this problem, usually dedicated design-for-debug (DFD) circuitries are added to the design to improve its observability.

Trace-based debug (see ARM (2013)) that allows designers to real-time observe a set of signals in consecutive cycles, being non-intrusive to the circuit's normal operation, is one of the most effective silicon debug techniques and has been widely adopted by the industry (see Leatherman and Stollon (2005) and Liu and Xu (2009)). To be specific, in this technique, a set of “key” signals in the CUD are tapped and they can be traced after being triggered. The sampled data are then sent to internal trace buffers and/or external trace ports via trace interconnection fabric (see Livengood and Medeiros (2007)), for later analysis by debug software and physical probing tools to further root cause and fix the bug (see Chang et al. (2007), Ko and Nicolici (2008) and Yang and Touba (2009)).

Once a bug is activated, it leaves its erroneous effects in one or more state elements of the circuit at some cycles. The objective of trace-based debug is to observe and localize such errors with as few debug runs as possible. Since it is not possible for us to trace all internal signals in the circuit, on one hand, the effectiveness of trace-based debug depends on the quality of the selected trace signals, which may include both manually-picked signals by experienced designers and signals selected via automated solutions guided by some visibility-enhancement metrics including Park et al. (2008), Lai et al. (2009), Vishnoi et al. (2009) and Anis et al. (2007). On the other hand, even with pre-determined trace signals that can capture a bug, it will only manifest itself at some specific time and it is crucial to ensure the signals at the “right” time are indeed traced.

Clearly, the more trace data that we can acquire, the higher possibility for us to catch a bug's erroneous effects in them and the less time and effort to identify the bug. Unfortunately, what we can trace in each debug run is usually quite limited. This is because, trace-based debug involves non-trivial overhead and we are only given limited trace buffer size and/or few external pins as trace ports.

Because of the above, it is not quite economical to store the “raw” trace data. In Park and Mitra (2008), Park and Mitra compressed the execution states of microprocessor into a small amount of footprints, taking advantage of the fact that the locality feature of instruction sequence and redundant information in monitored data that can be easily identified with the executed instructions. Yang and Touba. (2008) and Anis et al. (2007) utilized the data locality feature when accessing cache and adopted dictionary-based compression to improve the compression ratio.

The above trace compression solutions focused on debugging microprocessors. Several compression techniques have also been presented for signal tracing in general logic circuits to improve their error detection capability, and they can be broadly classified into the following three categories:

Lossless trace compressors, which take advantage of the locality of trace data for lossless compression. In Anis and Nicolici. (2007), Anis and Nicolici presented several dictionary-based compressors to trace repeatable data. Based on the observation that toggling rate of state values is usually low, Prabhakar et al. (2011) proposed to compress the differential data to achieve higher compression quality.

Spatial lossy trace compressors, which compact a set of N signals into M parity signals (N>M) using an XOR network before signal tracing starts (see Mitra et al. (2005)). To reduce routing overhead, such spatial compressors are usually organized as a tree-like structure as part of the trace interconnection fabric.

Temporal lossy trace compressors, which compact a number of cycles (e.g., 1 k) of the raw data into a signature during signal tracing (see Touba (2007) and Yang et al. (2009)) with the help of multiple-input signature register (MISR), originally used for test response compaction in VLSI testing domain. As shown in FIG. 1, with the assumption that the CUD behaves repeatable in different debug iterations, Anis and Nicolici (2007) consecutively zooms-in the failure signatures by reconfiguring the compaction ratio in their MISR-based compressor for each debug run to localize the error.

From the above, it is clear that temporal lossy trace compressors are quite appealing due to their impressive compression ratio. However, the effectiveness of such MISR-based compressors relies on the existence of clean “golden vector” to generate reference signatures for comparison. This is usually not the case during silicon debug, rendering the lossy compression technique less effective on error detection. This is because: (1) it is often too time-consuming to run gate-level simulation for failed silicon test, and hence designers often resort to high-level simulator to generate “golden vectors” and many unknown (X) bits are obtained when they are mapped onto gate-level vectors; and (2) asynchronous clock domains and uninitialized state elements also result in many X bits in functional patterns.

An objective of the present invention is to provide an effective and efficient X-tolerant temporal lossy trace compressor.

### SUMMARY OF INVENTION

The present invention, as suggested in the paper published by Yuan et al. (2012) at the Design Automation Conference, is an X-tolerant trace data compression scheme that produces compressed known (non-X) signature for silicon debug. It comprises a MISR-based trace compressor and an non-X signature extraction algorithm, where the MISR-based trace compressor takes any number of trace signals (to be observed signals for debugging purpose) containing any distribution of X's as inputs and outputs compressed X-contaminated trace data signatures, each bit of which is a linear combination of X bits and non-X information bits in the trace data. The non-X signature extraction algorithm is responsible for performing offline analysis on the X-contaminated trace data signatures and generating non-X signatures that keep a maximized number of non-X information bits.

Given a core under debug and a set of trace signals to be debugged, in the present invention, the MISR-based trace compressor may comprise one or more MISRs. Each MISR is implemented with a different primitive polynomial for connection to the same set of trace signals. The purpose is to provide redundant trace data signatures for X-tolerance. In one embodiment of the present invention, a reconfiguration capability is implemented in an MISR to enhance the diversity of redundancy. A first reconfiguration may use a primitive polynomial selector to select a desired primitive polynomial. A second reconfiguration may use an input order manipulator to change the positions of the trace signals. Furthermore, a reconfigurable counter may be used to set the number of cycles to unload a trace data signature. It is worth noting that any of the above reconfiguration schemes is independent of each other in constructing a trace compressor. The reconfiguration capability is compulsive when a trace compressor is implemented with one MISR, while it is optional to implement a trace compressor with two or more MISRs.

In another embodiment of the present invention, a non-X information extraction algorithm is used to convert an X-contaminated trace data signature to a non-X signature. Every bit in the X-contaminated trace data signature is a linear combination of X bits and non-X information bits. X bits are cancelled by identifying and XORing feasible combinations of bits in the X-contaminated trace data signature, and such combinations are named as X-cancelling schemes. Consequently, each bit in a resulting non-X signature is a linear combination of non-X information bits, and bugs are found if a mismatch occurs between the non-X signature and the known bug-free signature. In the present invention, an X-matrix may be first constructed, according to the X bit distribution in the X-contaminated trace data signature. Then, an X-cancelling scheme is a non-zero solution for the X-matrix. The X-matrix may be transformed into a column echelon form (see Cohen (2000)) that has the same solution space. A non-X signature extraction algorithm explores the X-cancelling solution space to maximize the number of kept non-X information bits using an X-cancelling solution transformation method, which generates an initial X-cancelling scheme and transforms one X-cancelling scheme to another one.

The foregoing and additional objects, features and advantages of the invention will become more apparent from the following detailed description, which proceeds with references to the following drawings.

### THE BRIEF DESCRIPTION OF DRAWINGS

FIG. 1 shows an infrastructure diagram of a trace-based hardware infrastructure for silicon debug, according to the present invention;

FIG. 2 is a high-level prior art architecture diagram of an encoder module;

FIG. 3 shows a prior art iterative debug flow;

FIG. 4 shows a first embodiment of a circuit diagram of two MISRs used in a MISR-based trace compressor, according to the present invention;

FIG. 5 shows a second embodiment of a circuit diagram of a reconfigurable MISR-based trace compressor, according to the present invention;

FIG. 6 shows a prior art X-cancelling technique example;

FIG. 7 shows an example of an X-cancelling solution transformation method for exploring X-cancelling solution space, according to the present invention; and

FIG. 8 shows a non-X signature extraction algorithm, according to the present invention.

### DETAILED DESCRIPTION OF THE INVENTION

The following description is presently contemplated as the best mode of carrying out the present invention. This description is not to be taken in a limiting sense but is made merely for the purpose of describing the principles of the invention. The scope of the invention should be determined by referring to the appended claims.

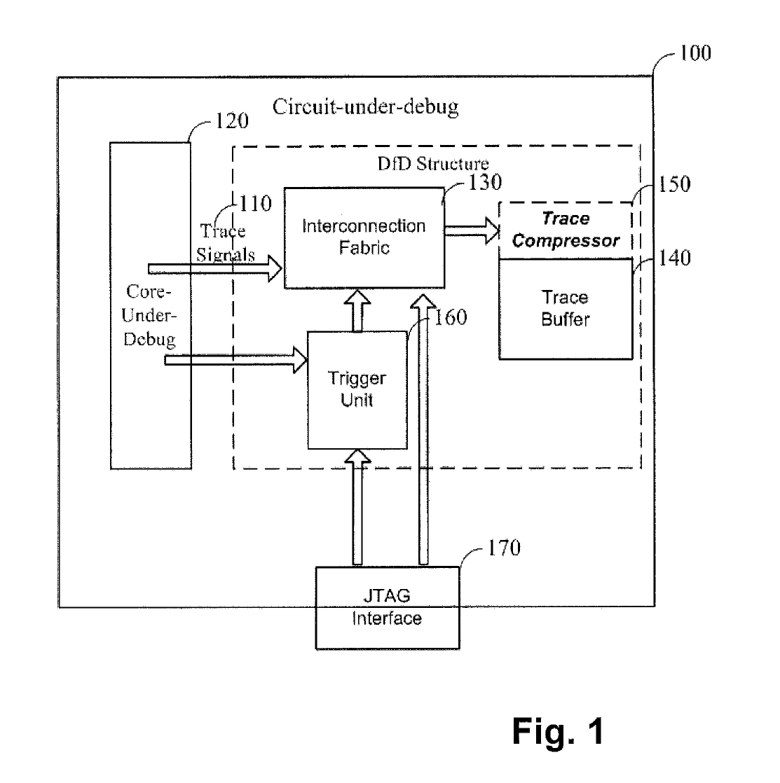

FIG. 1 depicts a hardware infrastructure diagram 100 for silicon debug using a trace buffer. As signal tracing involves non-trivial overhead, only some key Trace signals 110 in the Core-under-debug 120 can be tapped, typically in the thousand range for million-gate designs. An Interconnection fabric 130 is then used to link the trace signals to the ports of the Trace buffer 140. Within the interconnection fabric, signals are usually concentrated due to the limited trace buffer bandwidth. A Trace compressor 150, according to the present invention, is then included and placed in front of the Trace buffer 140 to extend its trace bandwidth. A Trigger unit 160 controls the start and stop of signal tracing, in which the triggering mechanism can be configured through a JTAG interface 170.

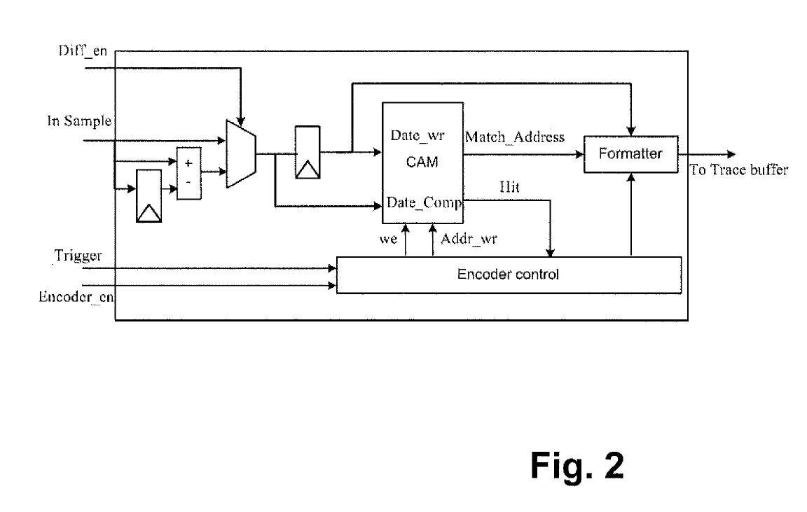

FIG. 2 shows a high-level prior art architecture diagram of an Encoder module 200 proposed in Anis and Nicolici (2007). A key feature of the Encoder module 200 is the use of a Content-addressable memory (CAM) to provide a pattern matching function or a lookup-function in a single clock cycle. CAMs are used in many real-time applications that require fast search speeds such as data compression algorithms. This Encoder module 200 facilitates dictionary-based lossless trace compression. In particular, Anis and Nicolici (2007) developed three implementations of the dynamic dictionary-based compression algorithms to achieve high compression ratio with low hardware cost.

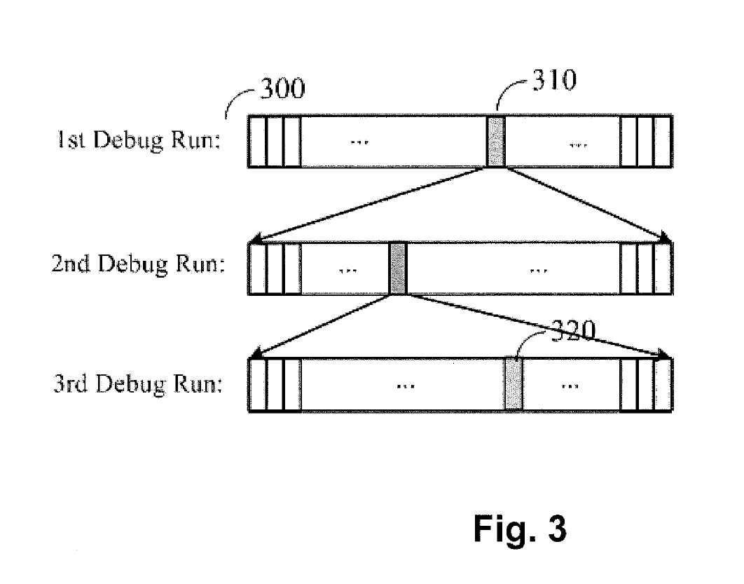

FIG. 3 shows a prior art iterative debug flow described in Anis and Nicolici (2007). A user can consecutively zoom-into the failure signatures by reconfiguring the compaction ratio in a MISR-based trace compressor during each debug run to localize the error. As an example, after the 1st Debug Run 310, a compressed signature with error 320 is identified. Then, by using the error information from the preceding debug session, the user can then set up another CUD configuration so he/she can zoom-into the erroneous time intervals during the 2nd Debug Run 320. As the example shows, this process is repeated iteratively until the exact error during the 3rd Debug Run 330 is localized.

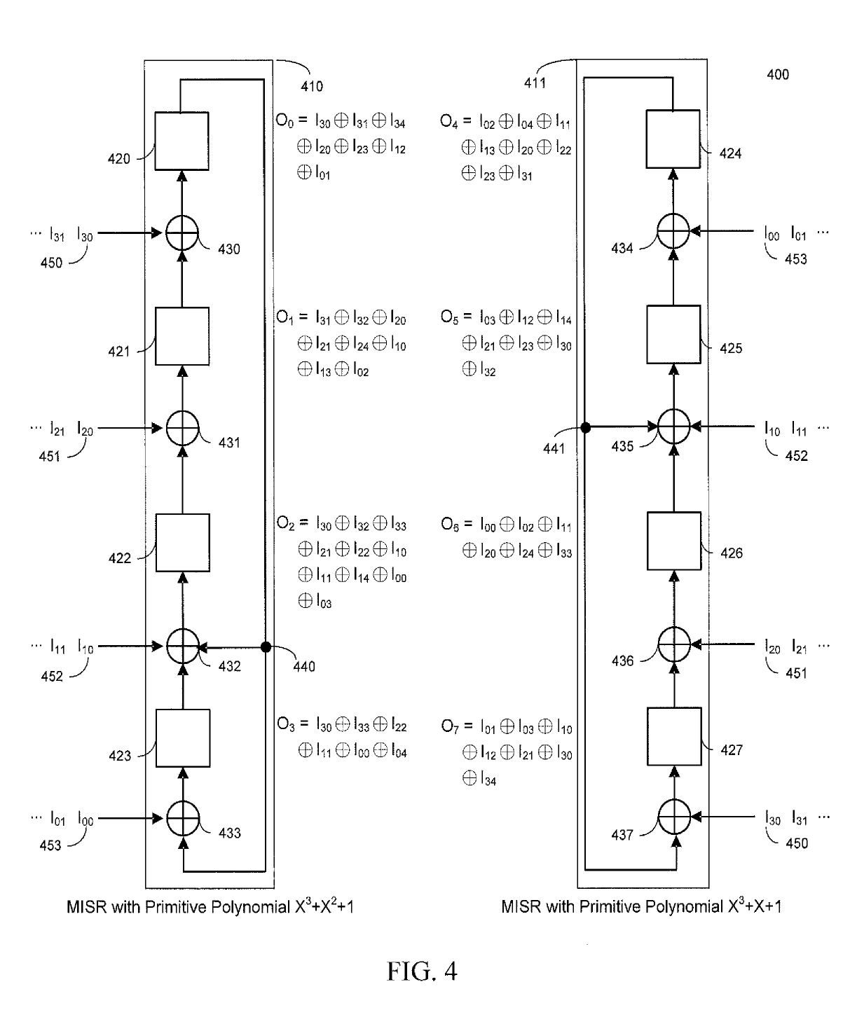

FIG. 4 shows a first embodiment of a circuit diagram 400 of two MISRs used in a MISR-based trace compressor, according to the present invention. The MISR-based trace compressor comprises two MISRs 410 and 411. MISR 410 consists of D flip-flops 420-423 and XOR gates 430-433. MISR 411 consists of D flip-flops 424-427 and XOR gates 434-437. The two MISRs are constructed with different Primitive polynomials as denoted in the feedback connections 440 and 441. In the Core-under-debug, trace signals 450-453 are concurrently connected to both MISRs as their input, and Trace data is compressed in a redundant manner. The X-contaminated trace data signature is represented by a symbol <O₀, O₁, O₂, O₃, O₄, O₅, O₆, O₇, >, where Oᵢ (0<=i<=7) is the output value of the i^{th} D flip-flop. Since MISR is a linear circuit, each X-contaminated trace data signature bit Oᵢ is a linear combination of trace data bit Iⱼₖ, where Iⱼₖ (0<=j<=3 and k>=0) is the logic value of the j^{th} trace signal at the k^{th} clock cycle. An X-contaminated trace data signature can then be obtained through symbolic simulation. As each X-contaminated trace data signature bit has a distinguished combination of X bits and non-X information bit, we can generate non-X signature by XORing certain X-contaminated trace data signature bits. For example, if I₀₃ is the only X bit in an X-contaminated trace data signature, its effect can be canceled by XORing O₇ with O₅ or by XORing O₂ with O₅.

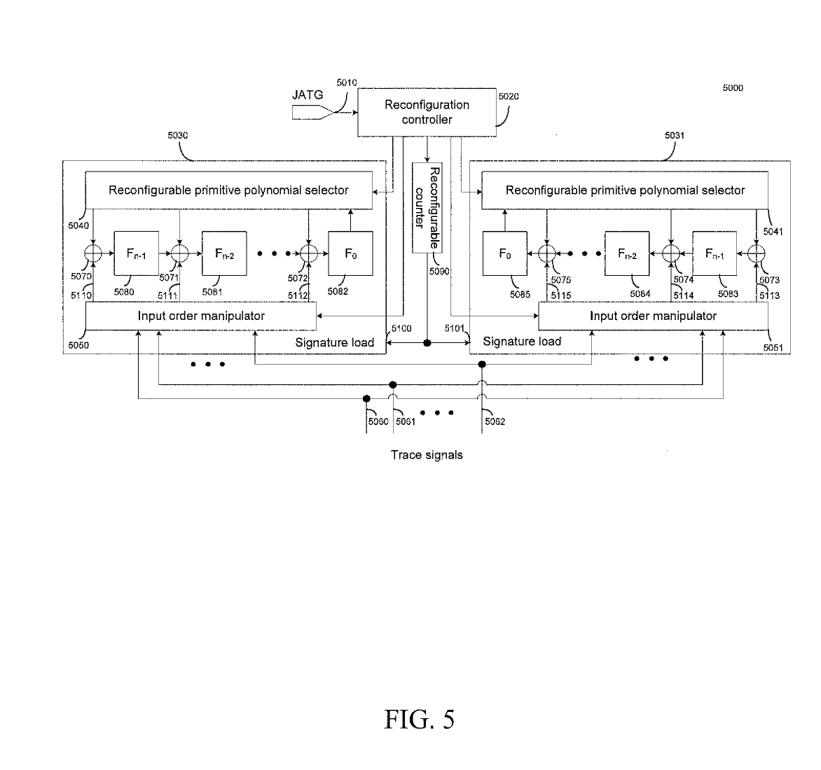

FIG. 5 shows a second embodiment of a circuit diagram 5000 of a reconfigurable MISR-based trace compressor, according to the present invention. The reconfigurable MISR-based trace compressor comprises two reconfigurable MISRs 5030 and 5031, which consist of D flip-flops 5080-5082 and 5083-5085, XOR gates 5070-5072 and 5073-5075, Reconfigurable primitive polynomial selectors 5040 and 5041, and Input order manipulators 5050 and 5051. The functionality of the two Reconfigurable primitive polynomial selectors 5040 and 5041 are to implement different Primitive polynomials for the two MISRs 5030 and 5031 by selectively switching on/off specific Primitive polynomial feedback connections, respectively. The two Input order manipulators are used to change the positions of Trace signals 5060-5062 at the inputs of MISR 5110-5112 and 5113-5115, respectively. A Reconfigurable counter 5090 is used to determine the number of cycles to unload X-contaminated trace data signatures for both MISRs in the trace compressor 5000. Please note that each of the above reconfigurable modules 5040, 5050, 5041, and 5051 may be controlled independently by a Reconfiguration controller 5020, which can be set through a JTAG interface 5010. Also, one or more of the above modules 5040, 5050, 5041, and 5051 may be implemented without reconfiguration capability to save hardware cost.

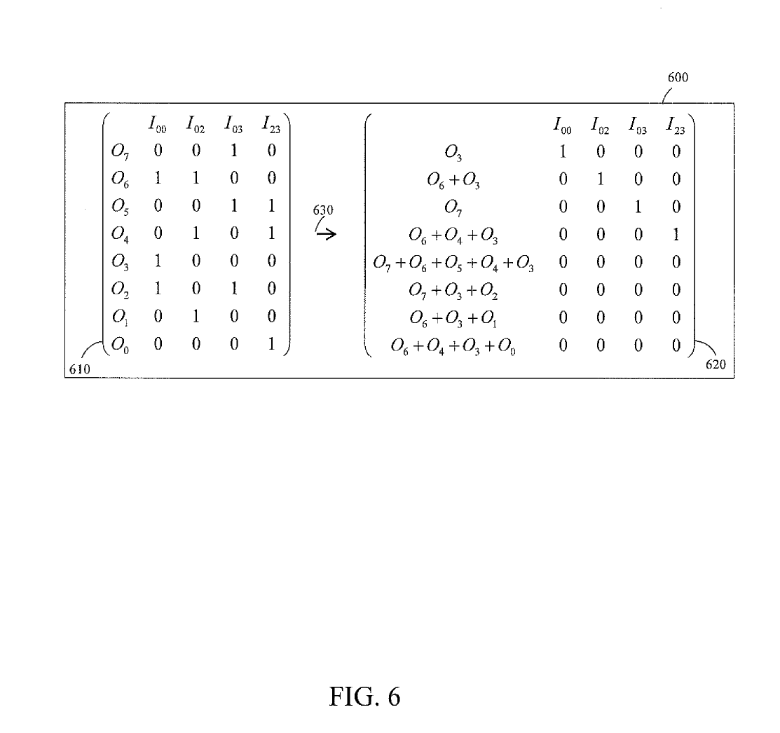

FIG. 6 shows a prior art X-cancelling technique example 600 proposed in Touba (2007). For the MISR-based trace compressor given in FIG. 4, the example is conducted assuming that I00, I02, I03, and I23 are X bits. First, an X-matrix 610 is constructed, wherein each row corresponds to one X-contaminated trace data signature bit and each column represents a specific X bit (entry ‘1’ denotes that the corresponding X bit affects the specific X-contaminated trace data signature bit). Next, by row transformation, a Gauss-Jordan elimination method 630 is performed to generate a reduced X-matrix 620, in which each all-zero row represents an X-cancelling scheme.

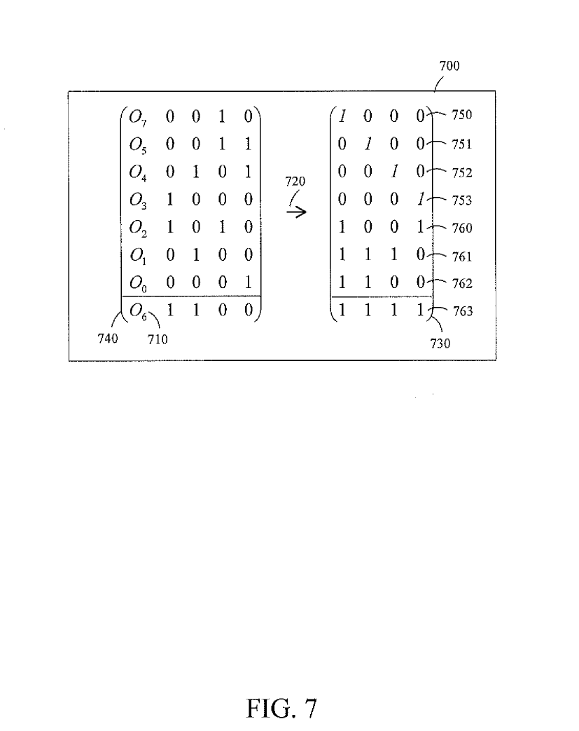

FIG. 7 shows an example of an X-cancelling solution transformation method 700 for exploring an X-cancelling solution space, according to the present invention. By selecting one targeted bit 710 of an X-contaminated trace data signature and moving the corresponding row down to the last position of an X-matrix 740, finding an X-cancelling scheme is to identify a combination of remaining bits to cancel the targeted bit. To achieve this objective, column operations 720 are performed to transfer the X-matrix to a column echelon form (see Cohen (2000)) 730. With the column echelon form of the X-matrix, the first non-zero entry in each column is called a pivot (in italic), and its corresponding row is called a pivot row 750-753, which is guaranteed to contain only one non-zero entry. In addition, an all-zero row is defined as a free row, and other rows are defined as stack rows 760-763. The last row corresponding to the targeted bit is referred to as the targeted row 763, which can be a pivot row, a free row or a stack row. According to linear algebra, if the targeted row is not a pivot row, then there exists at least one combination of the remaining bits to cancel the targeted bit, denoted as a solvable targeted bit. Let Vector S denote an X-cancelling scheme, where ‘1’ in S means that the corresponding X-contaminated trace data signature bit is included in the X-canceling scheme. For the example shown in FIG. 7, each bit in S corresponds to an X-contaminated trace data signature bit {O₇, O₅, O₄, O₃, O₂, O₁, O₀, O₆}. For the pivot rows, free rows and stack rows in the X-matrix in column echelon form, the corresponding bits in Vector S are defined as pivot bits, free bits and stack bits, respectively. Therefore, an initial X-cancelling scheme Sᵢₙᵢₜ can be found in the following manner: (1) identify non-zero entries on the last row of the X-matrix in column echelon form; (2) find the pivots on the same column; and (3) fill the targeted bit and the related pivot bits in Sᵢₙᵢₜ with 1s, and the rest with 0s. For the example shown in FIG. 7, an initial X-cancelling scheme could be Sᵢₙᵢₜ={1,1,1,1,0,0,0,1}, wherein the targeted column is represented as a linear combination of the pivot columns, i.e., O₆=O₇⊕O₅⊕O₄⊕O₃.

Starting from the initial X-cancelling scheme, an X-cancelling solution transformation method to explore the X-cancelling solution space is then used to generate new X-cancelling schemes. To guarantee that the obtained solution is still an X-cancelling scheme, the transformation method may obey the following three bit flipping rules: (1) any free bit can be freely flipped to generate a new X-cancelling scheme; (2) to flip a stack bit, all pivot bits whose corresponding pivots are on the same columns of non-zero entries of the stack row correlated with to-be-flipped stack bit, need to be flipped. For example, to flip the fifth bit O₂ in Sᵢₙᵢₜ, whose corresponding stack row is {1,0,0,1} 760, the first and fourth pivot bits, O₇ and O₃, need to be flipped. This is because column O₂ is equal to a linear combination of the columns corresponding to O₇ and O₃, i.e., O₂=O₇⊕O₃, and thus the above concurrent flipping operations cancel each other and generate a new X-cancelling scheme. In this case, a new X-cancelling scheme S_{sec}={0,1,1,0,1,0,0,1} is reached by performing the operation O₆=O₇⊕O₅⊕O₄⊕O₃⊕(O₂⊕O₇⊕O₃)=O₅⊕O₄⊕O₂; and (3) all pivot bits cannot be flipped. In addition, new X-cancelling schemes can be acquired by simply changing different targeted bits in the X-contaminated trace data signature.

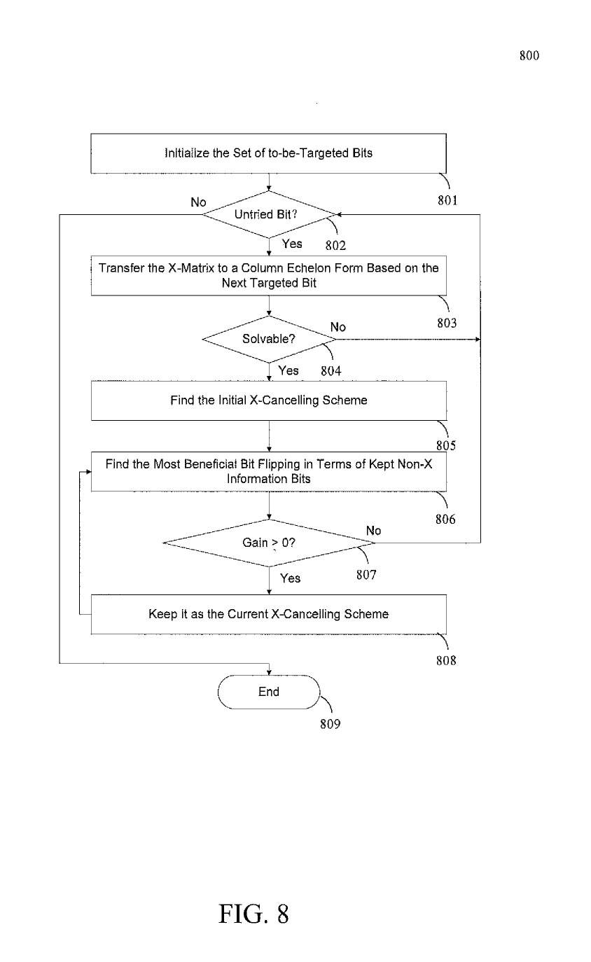

FIG. 8 shows a non-X signature extraction algorithm 800, according to the present invention. The objective is to generate X-cancelling schemes with the maximum number of kept non-X information bits for a given X-matrix that is constructed from an X-contaminated trace data signature. The algorithm starts by putting all bits in the X-contaminated trace data signature into a set of to-be-targeted bits in 801. An untried bit in 802 of the X-contaminated trace data signature is selected as the targeted bit each time. Based on the given X-matrix, the row associated with the targeted bit is moved to the last position of the X-matrix, and then a column operation is conducted to transfer the X-matrix to a column echelon form in 803. If the targeted bit is not solvable in 804, another targeted bit will be tried in 802; otherwise an initial X-cancelling scheme is constructed in 805. Then, an optimized X-cancelling scheme is searched in a greedy manner in 806-808 by iteratively flipping the most beneficial bit that provides the maximum gain in 806, where gain is defined as the increased number of kept non-X information bits. If no gain is obtained from the new X-cancelling scheme in 807, the algorithm will try another targeted bit in 802; otherwise it will keep the last solution as the current X-cancelling scheme in 808 before the next iteration. When all targeted bits have been tried, the algorithm is terminated in 809.

What is claimed is:

1. An apparatus using a multiple-input signature register based (MISR-based) trace compressor for compressing trace data for silicon debug in an integrated circuit, the integrated circuit comprising a core under debug and a plurality of trace signals to be debugged, said apparatus comprising:
(a) an interconnection fabric for accepting said trace data from one or more said trace signals;
(b) a MISR-based trace compressor comprising two or more MISRs for compressing said trace data from one or more said trace signals into one or more trace data signatures; and
(c) a trace buffer for storing said trace data signatures.

2. The apparatus of claim 1, wherein said MISR further comprises a select primitive polynomial or a reconfigurable primitive polynomial selector for selecting said select primitive polynomial of said MISR; wherein said reconfigurable primitive polynomial selector is selectively controlled by a reconfiguration controller.

3. The apparatus of claim 1, wherein said MISR further comprises a select input mapping order or an input order manipulator to select said select input mapping order of said MISR; wherein said input order manipulator is selectively controlled by a reconfiguration controller.

4. The apparatus of claim 1, further comprising a counter to unload said trace data signatures at a select cycle number; wherein said counter is selectively controlled by a reconfiguration controller.

5. The apparatus of claim 1, further comprising a JTAG interface to configure said MISR-based trace compressor externally.

6. A method using a multiple-input signature register based (MISR-based) trace compressor for compressing trace data for silicon debug in an integrated circuit, the integrated circuit comprising a core under debug and a plurality of trace signals to be debugged, said method comprising:
(a) using an interconnection fabric for accepting said trace data from one or more said trace signals;
(b) using a MISR-based trace compressor comprising two or more MISRs for compressing said trace data from one or more said trace signals into one or more trace data signatures; and
(c) using a trace buffer for storing said trace data signatures.

7. The method of claim 6, wherein said MISR further comprises a select primitive polynomial or a reconfigurable primitive polynomial selector for selecting said select primitive polynomial of said MISR; wherein said reconfigurable primitive polynomial selector is selectively controlled by a reconfiguration controller.

8. The method of claim 6, wherein said MISR further comprises a select input mapping order or an input order manipulator to select said select input mapping order of said MISR; wherein said input order manipulator is selectively controlled by a reconfiguration controller.

9. The method of claim 6, further comprising a counter to unload said trace data signatures at a select cycle number; wherein said counter is selectively controlled by a reconfiguration controller.

10. The method of claim 6, further comprising a JTAG interface to configure said MISR-based trace compressor externally.

11. An apparatus using a multiple-input signature register based (MISR-based) trace compressor for compressing trace data for silicon debug in an integrated circuit, the integrated circuit comprising a core under debug and a plurality of trace signals to be debugged, said apparatus comprising:
(a) an interconnection fabric for accepting said trace data from one or more said trace signals;
(b) a MISR-based trace compressor comprising a reconfigurable MISR for compressing said trace data from one or more said trace signals into one or more trace data signatures; and
(c) a trace buffer for storing said trace data signatures.

12. The apparatus of claim 11, wherein said reconfigurable MISR further comprises a reconfigurable primitive polynomial selector for selecting said select primitive polynomial of said MISR; wherein said reconfigurable primitive polynomial selector is selectively controlled by a reconfiguration controller.

13. The apparatus of claim 11, wherein said reconfigurable MISR further comprises an input order manipulator to select said select input mapping order of said MISR; wherein said input order manipulator is selectively controlled by a reconfiguration controller.

14. The apparatus of claim 11, further comprising a counter to unload said trace data signatures at a select cycle number; wherein said counter is selectively controlled by a reconfiguration controller.

15. The apparatus of claim 11, further comprising a JTAG interface to configure said MISR-based trace compressor externally.

16. A method using a multiple-input signature register based (MISR-based) trace compressor for compressing trace data for silicon debug in an integrated circuit, the integrated circuit comprising a core under debug and a plurality of trace signals to be debugged, said method comprising:
(a) using an interconnection fabric for accepting said trace data from one or more said trace signals;
(b) using a MISR-based trace compressor comprising one reconfigurable MISR for compressing said trace data from one or more said trace signals into one or more trace data signatures; and
(c) using a trace buffer for storing said trace data signatures.

17. The method of claim 16, wherein said MISR further comprises a reconfigurable primitive polynomial selector for selecting said select primitive polynomial of said MISR; wherein said reconfigurable primitive polynomial selector is selectively controlled by a reconfiguration controller.

18. The method of claim 16, wherein said MISR further comprises an input order manipulator to select said select input mapping order of said MISR; wherein said input order manipulator is selectively controlled by a reconfiguration controller.

19. The method of claim 16, further comprising a counter to unload said trace data signatures at a select cycle number; wherein said counter is selectively controlled by a reconfiguration controller.

20. The method of claim 16, further comprising a JTAG interface to configure said MISR-based trace compressor externally.

21. A method using X-cancelling solution transformation to generate a non-X signature from a given X-contaminated trace data signature that are linear combinations of X bits and non-X information bits, said method comprising:
(a) using the distribution of X bits in said given X-contaminated trace data signature to form an X-matrix;
(b) using column operations for transferring said X-matrix to a column echelon form, wherein said column echelon form of said X-matrix is categorized as a set of pivot rows, free rows and stack rows, in which a row that includes a pivot is called a pivot row, where a pivot is the first non-zero entry in each column; an all-zero row when available is defined as a free row, and any bit in said all-zero row is called a free bit; and other rows when available which are neither said pivot rows nor said free rows are defined as stack rows, and any bit in said stack row is called a stack bit; and
(c) using an X-cancelling solution transformation method to generate said non-X signature by converting an X-cancelling scheme to another X-cancelling scheme.

22. The method of claim 21, wherein said X-cancelling solution transformation method further comprises using a bit flipping rule, in which one or more said free bit in a said free row in said X-cancelling scheme are flipped to generate said another X-cancelling scheme.

23. The method of claim 21, wherein said X-cancelling solution transformation method further comprises using a bit flipping rule, in which to flip a said stack bit in a said stack row in said X-cancelling scheme, all said pivot bits whose corresponding pivots are on the same columns of non-zero entries of said stack row correlated with the to-be-flipped said stack bit, are flipped to generate said another X-cancelling scheme.
